(19) United States
(12) Patent Application Publication
(10) Pub. No.: US 2022/0414282 A1
(43) Pub. Date: Dec. 29, 2022

(54) BOUNDARY LAYER MESH GENERATION METHOD BASED ON ANISOTROPIC VOLUME HARMONIC FIELD

(71) Applicant: DALIAN UNIVERSITY OF TECHNOLOGY, Dalian, Liaoning (CN)

(72) Inventors: Shengfa WANG, Dalian, Liaoning (CN); Yiming ZHU, Dalian, Liaoning (CN); Xiaopeng ZHENG, Dalian, Liaoning (CN); Na LEI, Dalian, Liaoning (CN); Zhongxuan LUO, Dalian, Liaoning (CN); Fuwei CHEN, Dalian, Liaoning (CN); Yongjie WANG, Dalian, Liaoning (CN); Fan ZHANG, Dalian, Liaoning (CN)

(21) Appl. No.: 17/605,659

(22) PCT Filed: Dec. 15, 2020
(86) PCT No.: PCT/CN2020/136329

§ 371 Date: Oct. 22, 2021

(51) Int. Cl. G06F 30/15

(52) U.S. Cl. CPC G06F 30/15; G06F 2111/10

(57) ABSTRACT

The present invention discloses a boundary layer mesh generation method based on an anisotropic volume harmonic field, and belongs to the technical filed of computational fluid dynamics, numerical simulation, computer aided design and manufacturing. First, a boundary surface mesh of the Minkowski sum is used to construct a tetrahedral background mesh required for solving volume harmonic fields, then an anisotropic tensor is automatically added according to the actual demand, the anisotropic volume harmonic field is calculated under the control of the tensor, and finally, the advancing direction required by the boundary layer mesh is generated in combination with special weighted Laplace smoothing. The strategy of constructing a tetrahedral background mesh based on the boundary surface mesh of the Minkowski sum of the present invention reduces the calculation time and the memory waste, controllably and locally adjusts the thickness of the boundary layer mesh by automatically adding an anisotropic tensor, optimizes the advancing direction in combination with special weighted Laplace smoothing, and significantly improves the generation quality of the boundary layer mesh.

### TECHNICAL FIELD

The present invention belongs to the technical field of computational fluid dynamics, numerical simulation, computer aided design and manufacturing, and relates to a boundary layer mesh generation method based on an anisotropic volume harmonic field, which is suitable for boundary layer mesh generation of complex surfaces. The boundary layer mesh generated through induction is more flexible and controllable through control of tensors on the volume harmonic field.

### BACKGROUND

The boundary layer is a thin flow layer which is close to the object's surface and has non-negligible viscous force in the flow at high Reynolds number, and the quality of the boundary layer mesh directly determines the effect of numerical simulation. In the aerodynamic simulation of the flow at high Reynolds number, it is necessary to use a laminar anisotropic prism mesh perpendicular to an object to capture boundary layers near the viscous wall. The generation of prism meshes around the viscous wall is always the research focus in the technical field of computational fluid dynamics, numerical simulation, computer aided design and manufacturing. Prism meshes are generated mainly in two methods: a front node advancing method and a method based on solving partial differential equations. However, the anisotropy is generally not considered in the existing methods, i.e., the growth thickness of each layer is roughly the same. For special numerical simulation requirements, it is difficult to capture small physical features through isotropy. How to make the generated prism meshes more flexible and controllable is the research focus of boundary layer meshes.

### SUMMARY

In view of the above problems, the present invention proposes a boundary layer mesh generation method based on an anisotropic volume harmonic field. The method is based on solving partial differential equations to generate a boundary layer mesh, and comprises three summaries:

1. Construction of boundary surface mesh based on Minkowski sum and generation of tetrahedral background mesh (discrete computing field) of boundary layer space.

2. Calculation of anisotropic volume harmonic field based on local tensor control.

3. Boundary layer mesh (prism mesh) generation strategy of advancing distance and advancing direction calculated based on anisotropic volume harmonic field.

The technical solution of the present invention is as follows:

A boundary layer mesh generation method based on an anisotropic volume harmonic field comprises the following steps:

(1) Construction of boundary surface mesh based on Minkowski sum, and generation of tetrahedral background mesh (discrete computing field) of boundary layer space, with the specific steps as follows:

a) Inputting an original surface mesh (generally a triangular mesh or a quadrilateral mesh) and a spherical mesh with the radius of r (generally equal to the diagonal length of the smallest cuboid capable of wrapping the original surface mesh multiplied by a coefficient c, wherein c is generally [0.05, 0.3]) to calculate the boundary surface mesh of the Minkowski sum.

b) Optimizing the preliminarily obtained boundary surface mesh of the Minkowski sum, comprising nonmanifold elimination and self-intersection elimination, and finally obtaining a boundary surface mesh of two dimensional manifold.

c) Defining the boundary layer space as: a space between the boundary surface mesh of the Minkowski sum obtained by calculation and the original surface mesh (object's surface).

d) Using TetGen software to divide the boundary layer space into tetrahedral meshes, and checking whether four points of a tetrahedron element are simultaneously located on the boundary surface mesh of the boundary layer space in the tetrahedral background mesh. If yes, carrying out subdivision until the above condition does not exist.

e) Locally subdividing the slit of the tetrahedral background mesh. First, fixing the volume harmonic energy of the original surface mesh (object's surface) to a constant value a (generally 1), fixing the volume harmonic energy of the wrapping surface mesh to a constant value b (generally 0), setting an edge weight to the classic cotangent weight, and calculating the volume harmonic field of the tetrahedral background mesh; then performing breadth-first search (BFS) from the tetrahedron element near the original surface mesh (object's surface) to find tetrahedron elements with the difference of energy values of each edge less than the threshold Tₛₗᵢₜ (generally [0.01, 0.1]), and recording as a set Rₛₗᵢₜ; and finally, subdividing the tetrahedron elements in the set Rₛₗᵢₜ (generally for [2, 10] times). Using Delaunay to optimize the locally subdivided tetrahedral background mesh, then using Laplace smoothing to assist optimization, and finally obtaining a high quality tetrahedral background mesh.

(2) Calculation of anisotropic volume harmonic field based on local tensor control, with the specific content as follows:

2.1) Definition of Tensor on Vertex of Tetrahedral Background Mesh

T(υᵢ)=γ₁x₁x₁^{T}+γ₂x₂x₂^{T}+γ₃x₃x₃^{T}; (1)

wherein υᵢ is a vertex of the tetrahedral background mesh, [x₁, x₂, x₃] is a standard three dimensional orthogonal frame, and γ₁, γ₂, γ₃ are used as scalar factors in three directions of the standard orthogonal frame. Intuitively, the control of the tensor on the volume harmonic field can be regarded as placement of an ellipsoid on each vertex, as shown in FIG. 2, wherein the lengths of the sides of the ellipse along the major and minor axes indicate the degrees of control of the tensor on the volume harmonic field along the major and minor axes.

2.2) Definition of Anisotropic Volume Harmonic Field on Vertex of Tetrahedral Background Mesh

LH=0; (2)

wherein H is a vector composed of values of the volume harmonic field acting on all the vertexes; and L is a weight matrix, with the expression as follows:

$${L}_{ij} = \{ \begin{matrix}{\sum }_{{υ}_{k} ∈ N ( {υ}_{i} )} W ( {e}_{ik} ) , & i = j ; \\ - W ( {e}_{ij} ) , & {υ}_{j} ∈ N ( {υ}_{i} ) ; \\ 0 , & otherwise ;\end{matrix}$$

wherein υᵢ is a vertex of the tetrahedral background mesh, eᵢⱼ is an edge connecting υᵢ and υⱼ on the tetrahedral background mesh, eᵢⱼ is an edge connecting υᵢ and υⱼ on the tetrahedral background mesh, N(υᵢ) is a set of vertexes adjacent to υᵢ, and W(eᵢⱼ) is an edge weight for solving Laplace equations:

$$W ( {e}_{ij} ) exp ( ( \frac{{( {v}_{i} - {v}_{j} )}^{T}}{‖ {v}_{i} - {v}_{j} ‖} ( T ( {v}_{i} ) + T ( {v}_{j} ) ) \frac{( {v}_{i} - {v}_{j} )}{‖ {v}_{i} - {v}_{j} ‖} ) / δ ) ; \qquad ( 4 )$$

wherein δ>0, δ is a control factor (generally [0.001, 100]), and the less δ is, the greater the influence of tensors T(vᵢ) and T(vⱼ) on the edge weight W(eᵢⱼ) is; otherwise, the smaller the influence of tensors T(vᵢ) and T (vⱼ) on the edge weight W(eᵢⱼ) is.

2.3) Calculation of Anisotropic Volume Harmonic Field in Tetrahedral Background Mesh

Defining an anisotropic volume harmonic energy K(H):

$$K ( H ) = {\sum }_{{e}_{ij} ∈ E} W ( {e}_{ij} ) {( H ( {v}_{i} ) - H ( {v}_{j} ) )}^{2} \qquad ( 5 )$$

wherein E is a set of edges of the tetrahedral background mesh, and H(vᵢ) is the anisotropic volume harmonic energy at vᵢ.

Under the framework of an anisotropic volume harmonic field calculated by iteration, the edge weight can be simplified as follows:

W(eᵢⱼ)=exp(T(eᵢⱼ)/δ); (6)

Under the framework of the anisotropic volume harmonic field calculated by iteration, the optimization of the volume harmonic energy of the vertex is expressed as follows:

$$H ( {v}_{i} ) = \frac{{\sum }_{{v}_{j} ∈ N ( {v}_{i} )} W ( {e}_{i j} ) H ( {v}_{j} )}{{\sum }_{{v}_{j} ∈ N ( {v}_{i} )} W ( {e}_{i j} )} ; \qquad ( 7 )$$

The algorithm flow for calculating the anisotropic volume harmonic field by iteration is as follows:

Fixing the volume harmonic energy of the original surface mesh (object's surface) to a constant value a (generally 1) and fixing the volume harmonic energy of the wrapping surface mesh to a constant value b (generally 0); automatically adding local anisotropic tensor control according to the actual demand; setting the maximum iteration number Tᵢₜₑᵣ (generally 2000); setting the truncation threshold T_{energy} (generally 1.0*10⁻⁸) for optimization of the volume harmonic energy; iteratively updating H(vᵢ) through formula (7); calculating the volume harmonic energy K(H) every time the volume harmonic energy of all the vertexes is updated; and executing the iteration process until the maximum iteration number Tᵢₜₑᵣ is reached or K(H) reaches the truncation threshold T_{energy}.

2.4) Construction of Automatic Anisotropic Tensor Control

2.4.1) Under normal circumstances, limiting the gradient change rate of the volume harmonic field along the specific direction d, which is expressed as follows:

$$T ( {e}_{i j} ) = 1.0 - {( \frac{( {v}_{i} - {v}_{j} ) \cdot d}{‖ {v}_{i} - {v}_{j} ‖ * ‖ d ‖} )}^{2} ; \qquad ( 8 )$$

Applying the tensor constructed by formula (8) to the calculation of the volume harmonic field so that the gradient change rate along the direction d will be limited; and intuitively, the overall thickness of the boundary layer mesh (prism mesh) generated by the volume harmonic field based on the tensor control of formula (8) is significantly reduced along the direction d.

2.4.2) Limiting the gradient change rates of volume harmonic fields at concave edges and grooves, and to make the contour surface of the volume harmonic field obtained by calculation more close to the object's surface and avoid large distortion at concave edges and grooves caused by the boundary layer mesh generated through induction, automatically constructing a local tensor as follows:

First, setting the energy of the original surface mesh (object's surface) to a constant value a (generally 1), setting the energy of the wrapping surface mesh to a constant value b (generally 0), wherein a>b, setting an edge weight to the classic cotangent weight, and calculating the volume harmonic field of the tetrahedral background mesh; then performing breadth-first search (BFS) from the tetrahedron element near the original surface mesh (object's surface) to find tetrahedron elements with the difference of energy values of each edge less than the threshold Tₛₗᵢₜ (generally [0.01, 0.1]), and recording as a set Rₛₗᵢₜ; and finally, calculating the tensor, which is expressed as follows:

$$T ( {e}_{ij} ) = \{ \begin{matrix}( a - \frac{{H}_{0} ( {v}_{i} ) + {H}_{0} ( {v}_{j} )}{2} , & {e}_{ij} ∈ {R}_{slit} \\ a , & {e}_{ij} ∉ {R}_{slit}\end{matrix} \qquad ( 9 )$$

Applying the tensor constructed by formula (9) to the calculation of the volume harmonic field so that the gradient change rate of the volume harmonic field at concave edges and grooves will be limited; and intuitively, the distortion of the boundary layer mesh (prism mesh) generated by the volume harmonic field based on the tensor control of formula (9) is significantly reduced at concave edges and grooves.

2.4.3) Limiting the gradient change rate of the volume harmonic field at a slit between multiconnected branches, delaying the generation of saddle points of the volume harmonic field at the slit, and improving the quality of the boundary layer mesh generated through induction at the slit between multiconnected branches. Automatically constructing a local tensor as follows: supposing two volume models P and Q close to each other: first, respectively supposing H₁(P)=a, H₁(Q)=b and H₂(P)=b, and using H₂(Q)=a as Dirichlet boundary conditions (a is generally 1; and b is generally 0), setting an edge weight to the classic cotangent weight, and calculating two standard volume harmonic fields H₁ and H₂; and then calculating the tensor, which is expressed as follows:

$$T ( {e}_{i j} ) = 1. / exp ( \frac{‖ {H}_{1} ( {v}_{i} ) - {H}_{1} ( {v}_{j} ) ‖}{‖ {v}_{i} - {v}_{j} ‖} * \frac{‖ {H}_{2} ( {v}_{i} ) - {H}_{2} ( {v}_{j} ) ‖}{‖ {v}_{i} - {v}_{j} ‖} ) ; \qquad ( 10 )$$

Applying the tensor constructed by formula (10) to the calculation of the volume harmonic field so that the gradient change rate of the volume harmonic field at the slit between multiconnected branches will be limited; and intuitively, the distortion of the boundary layer mesh prism mesh) generated by the volume harmonic field based on the tensor control of formula (10) is significantly reduced at the slit.

(3) Boundary layer mesh (prism mesh) generation strategy of advancing distance and advancing direction calculated based on anisotropic volume harmonic field, with the specific content as follows:

3.1) Calculation of Advancing Distance of Front Node

The advancing distance of the front node is controlled through the gap between contour surfaces of the anisotropic volume harmonic field. The present invention converts the expected mesh thickness input by a user to a sampling energy, and calculates the positions of nodes of each layer through the sampling energy, which is implemented as follows:

First, the mesh thickness of each boundary layer is calculated according to the thickness L₁ of a first boundary layer, the thickness growth factor α of the boundary layer and the number n of boundary layers input by the user. Then, vertexes of the object's surface are set as front nodes, a front node with the curvature close to 0 is selected to trace back to the wrapping surface mesh along the gradient line of the volume harmonic field, and n sampling energies are extracted in the volume harmonic field according to the calculated mesh thickness of each boundary layer; and finally, for the volume harmonic field discretized in the tetrahedral background mesh, each tetrahedron element has a linear space inside, and the advancing position of the front node can be easily determined through the sampling energies under the guidance of the advancing direction of the front node.

3.2) Calculation of Advancing Direction of Front Node

The advancing direction of the front node is obtained by weighted Laplace smoothing of the gradient direction of the volume harmonic field, which is implemented as follows:

First, the gradient direction of the current position of the front node is calculated, and is generally the normal vector direction of the contour surface in the tetrahedron element where the front node is located; then the current position is recorded as pᵢ, and the next position p̅ᵢ is calculated under the guidance of the gradient direction and the next sampling energy, as shown in FIG. 3; and finally, the weight of Laplace smoothing is set as follows:

$$W ( {e}_{i j} ) = \{ \begin{matrix}1. / {R}_{i j k}^{p} + 1. / {R}_{i k l}^{p} \\ {R}_{ijk}^{q} + {R}_{i k l}^{q}\end{matrix} \qquad ( 11 )$$

wherein p (generally 4) and q (generally 2) are two control parameters, and in addition,

$${R}_{i j k} = \frac{( {\overline{p}}_{i} - {p}_{i} ) \times ( {\overline{p}}_{j} - {p}_{i} ) \cdot ( {\overline{p}}_{k} - {p}_{i} )}{( {p}_{i} - {\overline{p}}_{i} ) \times ( {p}_{k} - {\overline{p}}_{i} ) \cdot ( {p}_{j} - {\overline{p}}_{i} )} \qquad ( 12 )$$

Under this weight representation, whether the boundary layer mesh generated under the guidance of the advancing direction and the advancing distance has negative volume elements can be directly checked, which effectively guarantees the quality of the generated boundary layer mesh; and generally, the number of Laplace smoothing is set to 100.

3.3) Generation of Boundary Layer Mesh (Prism Mesh)

Under the guidance of the advancing distance and the advancing direction of the front node, a new group of advancing positions are obtained by calculation; and the boundary layer mesh is obtained by the directed connection of the advancing positions of all the front nodes according to the topology of the original surface mesh (object's surface).

The present invention has the following beneficial effects:

In view of the above summaries, the boundary layer mesh generation method based on an anisotropic volume harmonic field proposed by the present invention has three beneficial effects:

(1) In the traditional methods for constructing a tetrahedral background mesh (discrete computing field), a cuboid or a spheroid is used as the wrapping surface mesh, which introduces a large number of redundant tetrahedron elements and results in additional consumption of calculation. The generation of tetrahedral background meshes (discrete computing fields) based on the boundary surface mesh of the Minkowski sum can effectively eliminate the redundant tetrahedron elements, thus improving the utilization ratio of the memory and the execution efficiency of the algorithm.

(2) In the traditional boundary layer mesh generation methods based on solving partial differential equations, only the global information is considered, and local control and flexibility is lacked. The present invention realizes the control on the volume harmonic field by automatically constructing the local anisotropic tensor, which, on one hand, enables perception of local geometric information and strengthens the control on and the flexibility of locally generated meshes (mainly the control on the thickness of the boundary layer mesh), and on the other hand, makes the generated boundary layer mesh become dense along one or a plurality of directions according to the actual demand so that small physical features can be captured.

(3) The calculation strategy of the advancing distance and the advancing direction of the front node in the present invention has the following advantages:

a) To better combine the construction of the volume harmonic field and the generation of the boundary layer mesh, the present invention uses the distance between the contour surfaces of the volume harmonic field as guidance to control the advancing distances of the front nodes of each layer, i.e., the volume harmonic energy values of the nodes of each layer of the boundary layer mesh are equal in the tetrahedral background mesh (discrete computing field), and are on the same contour surface of the volume harmonic field. Based on this strategy, the coupling relationship between the volume harmonic field and the thickness of the boundary layer mesh is established so that the thickness of the boundary layer mesh is more flexible and controllable in order to achieve the purpose of locally controlling the thickness of the boundary layer mesh by local control on the volume harmonic field to meet the complex actual demand.

In the traditional methods for generating boundary layer meshes (prism meshes) based on partial differential equations, the gradient direction is generally used directly as the advancing direction, but a large number of negative volume or zero volume prism elements are easily introduced at concave edges and grooves. In addition, a lot of work is required to apply Laplace smoothing to the gradient direction to obtain a smoother advancing direction. The emphasis of the weighted Laplace smoothing strategy is on the design and selection of weights, which will directly affect the results of boundary layer mesh generation. The strategy adopted by the present invention uses the gradient direction to calculate the initial advancing position, and directly calculates the mass of the generated prism element in combination with the current position information, and the current mass of the prism element is used as the basis for setting a weight, which effectively avoids generation of negative volume prism elements.

### DESCRIPTION OF DRAWINGS

FIG. 1 is a flow chart of an algorithm of the present invention;

FIG. 2 is a schematic diagram of a tensor acting on a volume harmonic field on a vertex;

FIG. 3 is a schematic diagram of weight design of Laplace smoothing for optimizing the advancing direction;

FIGS. 4(a)-4(f) shows schematic diagrams of generating boundary layer meshes by an aircraft model based on an anisotropic volume harmonic field, (a) an original surface (object's surface) mesh of an aircraft model; (b) a wrapping surface mesh of an aircraft model; (c) an original (object's surface) mesh of an aircraft model; (d) the cross section of a contour surface of a standard volume harmonic field of an aircraft model; (e) the cross section of a contour surface of an anisotropic volume harmonic field of an aircraft model; and (f) a boundary layer network of an aircraft model based on an anisotropic volume harmonic field.

### DETAILED DESCRIPTION OF THE UTILITY MODEL

Specific embodiments of the present invention are further described in detail below in combination with the drawings and the technical solution.

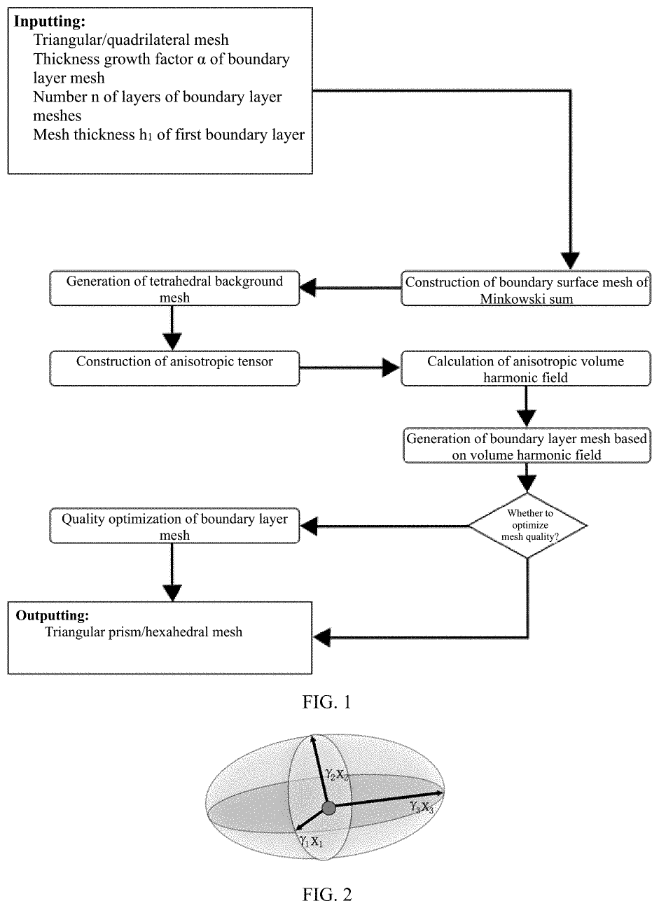

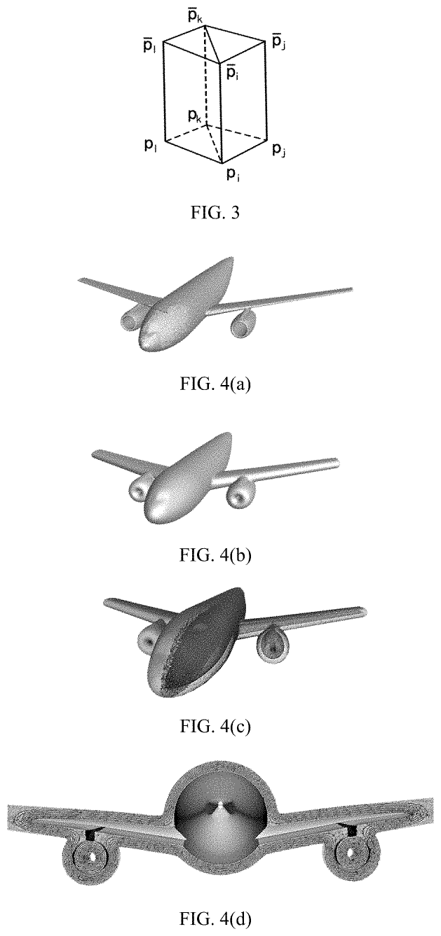

The algorithm flow of the present invention is shown in FIG. 1, comprising five steps: constructing a boundary surface mesh of the Minkowski sum; generating a tetrahedral background mesh (discrete computing field) for a boundary layer space; constructing an anisotropic tensor; calculating an anisotropic volume harmonic field; and generating a boundary layer mesh (prism mesh) based on the anisotropic volume harmonic field. The inputs of the algorithm of the present invention comprise one original surface mesh (object's surface) and three parameters, wherein the original surface mesh (object's surface) can be a triangular mesh or a quadrilateral mesh; and the three parameters are respectively the mesh thickness L₁ of a first boundary layer, the thickness growth factor α of the boundary layer mesh and the number n of layers of boundary layer meshes.

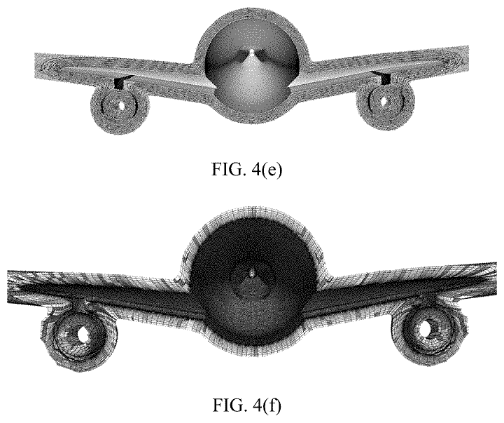

The embodiment takes the specific implementation of generating a boundary layer mesh by an aircraft model based on an anisotropic volume harmonic field as an example of the present invention, as shown in FIG. 4, and the specific steps are as follows:

1. Inputting an aircraft model (triangular mesh); inputting parameters L₁=1.0*10⁻², α=1.15 and n=60; calculating the desired mesh thickness {L₁, L₂, . . . , Lₙ} of each boundary layer according to the input parameters L₁, α and n, wherein Lᵢ₊₁=Lᵢ*α; and calculating the desired overall thickness Lₜₒₜₐₗ=Σᵢ₌₀ⁿ⁻¹αⁱ*L₁ of boundary layer meshes;

2. Setting the mesh radius of a spheroid to Lₜₒₜₐₗ*1.5, and calculating the boundary surface mesh of the Minkowski sum of the original surface mesh (object's surface) as a wrapping surface mesh; and eliminating the nonmanifold area and the self-intersection area of the wrapping surface mesh;

3. Using TetGen commercial software to divide the boundary layer space between the original surface mesh (object's surface) and the wrapping surface mesh into tetrahedral meshes to obtain a tetrahedral background mesh (discrete computing field); and checking whether four points of a tetrahedron element are simultaneously located on the boundary surface mesh of the boundary layer space in the tetrahedral background mesh. If yes, carrying out subdivision until the above condition does not exist;

4. Fixing the volume harmonic energy of the original surface mesh (object's surface) to 1, fixing the volume harmonic energy of the wrapping surface mesh to 0, setting an edge weight to the classic cotangent weight, and calculating the volume harmonic field of the tetrahedral background mesh; performing breadth-first search (BFS) from the tetrahedron element attached to the original surface mesh (object's surface) to find tetrahedron elements with the difference of energy values of each edge less than the threshold 0.05, and recording as a set Rₛₗᵢₜ; and calculating a local tensor according to formula (9);

5. Fixing the volume harmonic energy of the original surface mesh (object's surface) to 1, and fixing the volume harmonic energy of the wrapping surface mesh to 0; calculating the weight of each edge according to formula (6) based on an anisotropic tensor, wherein the control factor δ is set to 0.05; setting the maximum iteration number to 2000, and setting the energy truncation threshold to 1.0*10⁻⁸; iteratively updating the volume harmonic energy value of a vertex through formula (7), and calculating a new volume harmonic energy K(H) according to (5) every 50 iterations; and if the difference between the current volume harmonic energy value and the previous volume harmonic energy value is less than the truncation threshold, stopping iteration; otherwise, continuing iteration until the maximum iteration number is reached;

6. Setting vertexes of the original surface mesh (object's surface) as front nodes, selecting a front node with the curvature close to 0 to trace back to the wrapping surface mesh along the gradient line of the volume harmonic field, and extracting n sampling energies {K₁, K₂, . . . , Kₙ} in the trace according to the calculated mesh thickness {L₁, L₂, . . . , Lₙ} of each boundary layer;

7. Using the gradient direction of the current position of the front node as the initial advancing direction, using formula (11) as the weight of the weighted Laplace smoothing to optimize the advancing direction, and setting the number of smoothing to 100;

8. Calculating the advancing position of the front node based on the optimized advancing direction and the sampling energy Kᵢ; recalculating the advancing direction every time the front node is advanced; and carrying out simple directed connection of n advancing positions corresponding to all the front nodes according to the topology of the original surface mesh (object's surface) to obtain a boundary layer mesh (prism mesh).

1. A boundary layer mesh generation method based on an anisotropic volume harmonic field, comprising the following steps:
(1) construction of boundary surface mesh based on Minkowski sum and generation of tetrahedral background mesh of boundary layer space
a) inputting an original surface mesh and a spherical mesh with the radius of r to calculate the boundary surface mesh of the Minkowski sum;
b) optimizing the preliminarily obtained boundary surface mesh of the Minkowski sum, comprising nonmanifold elimination and self-intersection elimination, and finally obtaining a boundary surface mesh of two dimensional manifold;
c) defining the boundary layer space as: a space between the boundary surface mesh of the Minkowski sum obtained by calculation and the original surface mesh;
d) dividing the boundary layer space into tetrahedral meshes, and checking whether four points of a tetrahedron element are simultaneously located on the boundary surface mesh of the boundary layer space in the tetrahedral background mesh; if yes, carrying out subdivision until the above condition does not exist;
e) locally subdividing the slit of the tetrahedral background mesh, optimizing the locally refined tetrahedral background mesh, then using Laplace smoothing to assist optimization, and finally obtaining a high quality tetrahedral background mesh;
(2) calculation of anisotropic volume harmonic field based on local tensor control
1) definition of tensor on vertex of tetrahedral background mesh:
T(υᵢ)=γ₁x₁x₁^{T}+γ₂x₂x₂^{T}+γ₃x₃x₃^{T}; (1)
wherein υᵢ is a vertex of the tetrahedral background mesh, [x₁, x₂, x₃] is a standard three dimensional orthogonal frame, and γ₁, γ₂, γ₃ are used as scalar factors in three directions of the standard orthogonal frame;
2) definition of anisotropic volume harmonic field on vertex of tetrahedral background mesh:
LH=0; (2)
wherein H is a vector composed of values of the anisotropic volume harmonic field acting on all the vertexes; and L is a weight matrix, with the expression as follows:
$${L}_{i j} = \{ \begin{matrix}{\sum }_{{υ}_{k} ∈ N ( {υ}_{i} )} W ( {e}_{i k} ) , & i = j ; \\ - W ( {e}_{i j} ) , & {υ}_{j} ∈ N ( {υ}_{i} ) ; \\ 0 , & others ;\end{matrix} \begin{matrix} \\ \end{matrix} \qquad ( 3 )$$
wherein υᵢ is a vertex of the tetrahedral background mesh, eᵢⱼ is an edge connecting υᵢ and υⱼ on the tetrahedral background mesh, N(υᵢ) is a set of vertexes adjacent to υᵢ, and W(eᵢⱼ) is an edge weight for solving Laplace equations:
$$W ( {e}_{i j} ) = exp ( ( \frac{{( {v}_{i} - {v}_{j} )}^{T}}{‖ {v}_{i} - {v}_{j} ‖} ( T ( {v}_{i} ) + T ( {v}_{j} ) ) \frac{( {v}_{i} - {v}_{j} )}{‖ {v}_{i} - {v}_{j} ‖} ) / δ ) ; \qquad ( 4 )$$
wherein δ>0, δ is a control factor, and the less δ is, the greater the influence of tensors T(vᵢ) and T(vⱼ) on the edge weight W(eᵢⱼ) is; otherwise, the smaller the influence of tensors T(vᵢ) and T(vⱼ) on the edge weight W(eᵢⱼ) is;
3) calculation of anisotropic volume harmonic field in tetrahedral background mesh:
defining an anisotropic volume harmonic energy K(H)
$$K ( H ) = {\sum }_{{e}_{i j} ∈ E} W ( {e}_{i j} ) {( H ( {v}_{i} ) - H ( {v}_{j} ) )}^{2} ; \qquad ( 5 )$$
wherein E is a set of edges of the tetrahedral background mesh, and H(vᵢ) is the anisotropic volume harmonic energy at vᵢ;
under the framework of an anisotropic volume harmonic field calculated by iteration, the edge weight is simplified as follows:
W(eᵢⱼ)=exp(T(eᵢⱼ)/δ); (6)
under the framework of the anisotropic volume harmonic field calculated by iteration, the optimization of the volume harmonic energy of the vertex is expressed as follows:
$$H ( v i ) = \frac{{\sum }_{{v}_{j} ∈ N ( {v}_{i} )} W ( {e}_{i j} ) H ( {v}_{j} )}{{\sum }_{{v}_{j} ∈ N ( {v}_{i} )} W ( {e}_{i j} )} ; \qquad ( 7 )$$
the algorithm flow for calculating the anisotropic volume harmonic field by iteration is as follows:
fixing the volume harmonic energy of the original surface mesh to a constant value a and fixing the volume harmonic energy of the wrapping surface mesh to a constant value b; automatically adding local anisotropic tensor control according to the actual demand; setting the maximum iteration number Tᵢₜₑᵣ; setting the truncation threshold T_{energy} for optimization of the volume harmonic energy; iteratively updating H(vᵢ) through formula (7); calculating the volume harmonic energy K(H) every time the volume harmonic energy of all the vertexes is updated; and executing the iteration process until the maximum iteration number Tᵢₜₑᵣ is reached or K(H) reaches the truncation threshold T_{energy};
4) construction of automatic anisotropic tensor control:
4.1) limiting the gradient change rate of the volume harmonic field along the specific direction d, which is expressed as follows:
$$T ( {e}_{i j} ) = 1.0 - {( \frac{( {v}_{i} - {v}_{j} ) \cdot d}{‖ {v}_{i} - {v}_{j} ‖ * ‖ d ‖} )}^{2} ; \qquad ( 8 )$$
applying the tensor constructed by formula (8) to the calculation of the volume harmonic field so that the gradient change rate along the direction d will be limited; and intuitively, the overall thickness of the boundary layer mesh generated by the volume harmonic field based on the tensor control of formula (8) is significantly reduced along the direction d;
4.2) limiting the gradient change rates of volume harmonic fields at concave edges and grooves, and to make the contour surface of the volume harmonic field obtained by calculation more close to the object's surface and avoid large distortion at concave edges and grooves caused by the boundary layer mesh generated through induction, automatically constructing a local tensor as follows:
first, setting the volume harmonic energy of the original surface mesh to a constant value a, setting the energy of the wrapping surface mesh to a constant value b, wherein a>b, and calculating the volume harmonic field of the tetrahedral background mesh; then performing breadth-first search from the tetrahedron element near the original surface mesh to find tetrahedron elements with the difference of energy values of each edge less than the threshold Tₛₗᵢₜ, and recording as a set Rₛₗᵢₜ; and finally, calculating the tensor, which is expressed as follows:
$$T ( {e}_{ij} ) = \{ \begin{matrix}( a - \frac{{H}_{0} ( {v}_{i} ) + {H}_{0} ( {v}_{j} )}{2} , & {e}_{ij} ∈ {R}_{slit} \\ a , & {e}_{ij} ∉ {R}_{slit}\end{matrix} \qquad ( 9 )$$
applying the tensor constructed by formula (9) to the calculation of the volume harmonic field so that the gradient change rate of the volume harmonic field at concave edges and grooves will be limited; and intuitively, the distortion of the boundary layer mesh generated by the volume harmonic field based on the tensor control of formula (9) is significantly reduced at concave edges and grooves;
4.3) limiting the gradient change rate of the volume harmonic field at a slit between multiconnected branches, delaying the generation of saddle points of the volume harmonic field at the slit, and improving the quality of the boundary layer mesh generated through induction at the slit between multiconnected branches; and automatically constructing a local tensor as follows: supposing two volume models P and Q close to each other: first, respectively supposing H₁(P)=a, H₁(Q)=b and H₂(P)=b, and using H₂(Q)=a as Dirichlet boundary conditions to calculate two standard volume harmonic fields H₁ and H₂; and then calculating the tensor, which is expressed as follows:
$$T ( {e}_{i j} ) = 1. / exp ( \frac{‖ {H}_{1} ( {v}_{i} ) - {H}_{1} ( {v}_{j} ) ‖}{‖ {v}_{i} - {v}_{j} ‖} * \frac{‖ {H}_{2} ( {v}_{i} ) - {H}_{2} ( {v}_{j} ) ‖}{‖ {v}_{i} - {v}_{j} ‖} ) ; \qquad ( 10 )$$
applying the tensor constructed by formula (10) to the calculation of the volume harmonic field so that the gradient change rate of the volume harmonic field at the slit between multiconnected branches will be limited; and intuitively, the distortion of the boundary layer mesh generated by the volume harmonic field based on the tensor control of formula (10) is significantly reduced at the slit;
(3) boundary layer mesh generation strategy of advancing distance and advancing direction calculated based on anisotropic volume harmonic field calculation of advancing distance of front node:
the advancing distance of the front node is controlled through the gap between contour surfaces of the anisotropic volume harmonic field; and the expected mesh thickness input by a user is converted to a sampling energy, and the positions of nodes of each layer are calculated through the sampling energy, which is implemented as follows:
first, the mesh thickness of each boundary layer is calculated according to the thickness L₁ of a first boundary layer, the thickness growth factor α of the boundary layer and the number n of boundary layers input by the user; then, vertexes of the object's surface are set as front nodes, a front node with the curvature close to 0 is selected to trace back to the wrapping surface mesh along the gradient line of the volume harmonic field, and n sampling energies are extracted in the volume harmonic field according to the calculated mesh thickness of each boundary layer; and finally, for the volume harmonic field discretized in the tetrahedral background mesh, each tetrahedron element has a linear space inside, and the advancing position of the front node can be easily determined through the sampling energies under the guidance of the advancing direction of the front node;
a) calculation of advancing direction of front node:
the advancing direction of the front node is obtained by weighted Laplace smoothing of the gradient direction of the volume harmonic field, which is implemented as follows:
first, the gradient direction of the current position of the front node is calculated, and is the normal vector direction of the contour surface in the tetrahedron element where the front node is located; then the current position is recorded as pᵢ, and the next position p̅ᵢ is calculated under the guidance of the gradient direction and the next sampling energy; and finally, the weight of Laplace smoothing is set as follows:
$$W ( {e}_{i j} ) = \{ \begin{matrix}1. / {R}_{i j k}^{p} + 1. / {R}_{i k l}^{p} \\ {R}_{ijk}^{q} + {R}_{i k l}^{q}\end{matrix} \qquad ( 11 )$$
wherein p and q are two control parameters, and in addition,
$${R}_{i j k} = \frac{( {\overline{p}}_{i} - {p}_{i} ) \times ( {\overline{p}}_{j} - {p}_{i} ) \cdot ( {\overline{p}}_{k} - {p}_{i} )}{( {p}_{i} - {\overline{p}}_{i} ) \times ( {p}_{k} - {\overline{p}}_{i} ) \cdot ( {p}_{j} - {\overline{p}}_{i} )} \qquad ( 12 )$$
under this weight representation, whether the boundary layer mesh generated under the guidance of the advancing direction and the advancing distance has negative volume elements can be directly checked, which effectively guarantees the quality of the generated boundary layer mesh;
b) generation of boundary layer mesh:
under the guidance of the advancing distance and the advancing direction of the front node, a new group of advancing positions are obtained by calculation; and the boundary layer mesh is obtained by the directed connection of the advancing positions of all the front nodes according to the topology of the original surface mesh.
